(19) United States
(12) Patent Application Publication
(10) Pub. No.: US 2011/0126121 A1
(43) Pub. Date: May 26, 2011

(54) MARKETING SYSTEM HAVING MULTIPLE FULFILLMENT CHANNELS AND A METHOD FOR DIRECTING A PERSONALIZED INVITATION TO MEMBERS OF A SOCIAL NETWORK

(76) Inventors: David E. Farmer, Holland, MI (US); Stephen R. Perkins, Flower Mound, TX (US); Donovan Dillon, Plano, TX (US)

(21) Appl. No.: 12/950,343

(22) Filed: Nov. 19, 2010

Related U.S. Application Data
(60) Provisional application No. 61/263,148, filed on Nov. 20, 2009.

(51) Int. Cl. G06F 15/16; G06F 3/01

(52) U.S. Cl. 715/744; 709/203

(57) ABSTRACT

A marketing system (10) includes a server (12) for hosting a marking campaign, the server (12) being in data communication with a social network channel (22), wherein the server (12) distributes an invitation through the social network channel (22) to a follower of a user of a social network associated with the social network channel (22), and a sitelet channel (24) in data communication with the server (12), wherein the sitelet channel (24) includes a dynamic website (26), and wherein the invitation directs the follower of the user of the associated social network to the dynamic website (26).

### CROSS-REFERENCE TO RELATED APPLICATION

This application claims the benefit of U.S. Provisional Patent Application No. 61/263,148 filed on Nov. 20, 2009.

### FIELD OF THE INVENTION

The present invention relates generally to marketing networks. More particularly, the invention is directed to a personalized marketing system having multiple fulfillment channels and a method for directing personalized invitations to social network members.

### BACKGROUND OF THE INVENTION

Advertising programs typically are created by advertising agencies on behalf of clients that desire to advertise products and/or services locally, nationally, or both. The advertising agencies control the “assets” (the advertising materials to be used) and placement with the media. Typically, advertising agencies promote the client's products and/or services through multiple channels, such as a print media and a broadcast media, for example. However, social media networks represent an emerging source of media allowing a new method of coverage for marketing campaigns. For example, the Twitter® social media network Twitter currently has over 105 million registered users, with 300,000 new users signing up every day. (See http://www.pcadvisor.co.uk/news/index.cfm?newsid=3220448 and http://www.reuters.com/article/idUSTRE63D46P20100415).

It would be desirable to develop a marketing system having multiple fulfillment channels including a social network channel and a method for directing a follower of a social network user to a marketing site, wherein the marketing system and method include a social network such as Twitter® as a fulfillment channel in the marketing system to maximize media coverage of a marketing campaign.

### SUMMARY OF THE INVENTION

Concordant and consistent with the present invention, a marketing system having multiple fulfillment channels including a social network channel and a method for directing a follower of a social network user to a marketing site, wherein the marketing system and method include a social network such as Twitter® as a fulfillment channel in the marketing system to maximize media coverage of a marketing campaign, has surprisingly been discovered.

The marketing system and the method of the present invention provide an efficient, one-to-many invitation means for reaching individual members of a social network in a personalized manner, thereby enabling the engagement of each responder in a personalized, one-to-one dialog (via a personalized marketing website or sitelet).

In one embodiment, a marketing system comprises: a server for hosting a marking campaign; a social network channel in data communication with the server, wherein the server distributes an invitation through the social network channel to a follower of a user of an associated social network; and a sitelet channel in data communication with the server, wherein the sitelet channel includes a dynamic website, and wherein the invitation directs the follower of the user of the associated social network to the dynamic website.

The invention also provides methods for directing a follower of a social network user to a personalized marketing site.

One method comprises the steps of: retrieving a list of followers associated with a user account of the social network, the list of followers including personal information relating to each member of the list of followers; generating a personalized uniform resource locator for at least one member of the list of followers based upon the personal information relating to the at least one member of the list of followers; generating a dynamic website accessible via the personalized uniform resource locator; and transmitting an invitation to the at least one member of the list of followers, the invitation embedded with the personalized uniform resource locator to direct the at least one member of the list of followers to the dynamic website.

Another method comprises the steps of:
a. providing a server to host a marketing campaign including a campaign template having a plurality of pre-defined fields for customization, localization and personalization of campaign messaging;
b. wherein the server retrieves a list of followers associated with the user account, the list of followers including personal information associated with each of the followers;
c. wherein the server generates a personalized uniform resource locator for each member of the list of followers based upon the personal information associated with each of the followers;
d. wherein the server transmits a personalized invitation to each member of the list of followers, each of the invitations embedded with the personalized uniform resource locator for each member of the list of followers; and
e. wherein the server generates a dynamic website accessible via the personalized uniform resource locator.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a marketing system according to an embodiment of the present invention; and

FIG. 2 is a schematic flow diagram of a method for directing a follower of a social network to a personalized marketing site according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

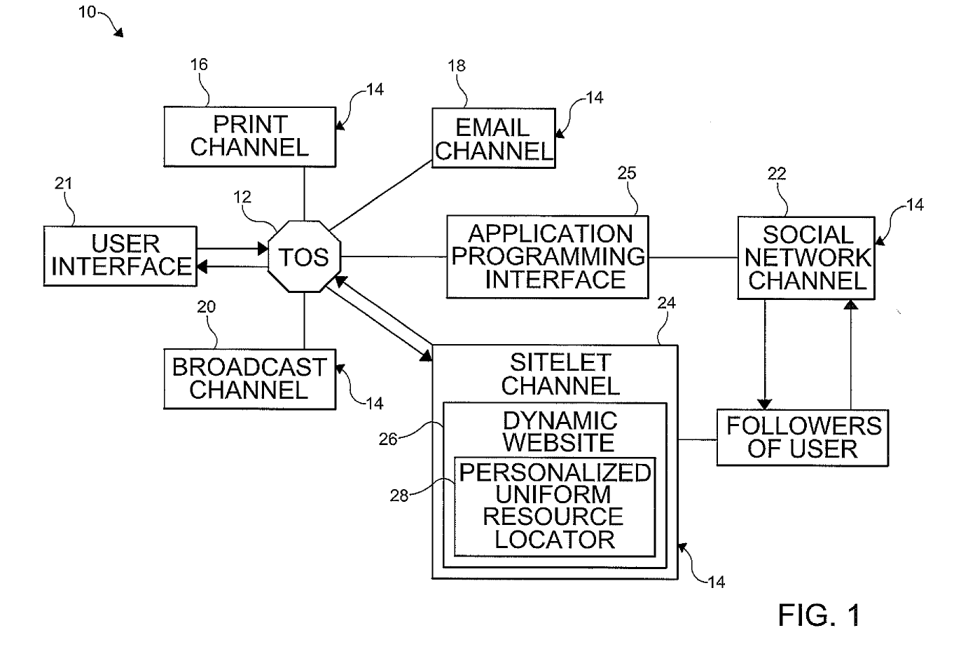

Referring to FIG. 1, there is illustrated a marketing system 10 according to an embodiment of the present invention. As shown, the marketing system 10 includes a Transaction Operations Server (TOS) 12 in data communication with a plurality of fulfillment channels 14 to provide various media outlets for a hosted marketing campaign. It is understood that the TOS 12 may be any server using any platform and may include The ONE System® or MODsocket® provided by Ad Giants, LLC and described on the website http://www.adgiants.com. It is further understood that any number of fulfillment channels 14 may be used such as a print channel 16, an e-mail channel 18, and a broadcast channel 20, for example. Accordingly, the marketing campaign can include various campaigning strategies including print media, e-mail, and television/radio broadcasts, for example. Other media and means for fulfilling the marketing campaign can be used. In certain embodiments a user interface 21 is in data communication with the TOS 12 to configure the marketing campaign.

In the embodiment shown, the fulfillment channels 14 include a social network channel 22 (e.g. a Twitter fulfillment channel) and a sitelet channel 24. As a non-limiting example, the following description is limited to the Twitter® social media network. However, it is understood that other social networks may be included in the marketing system 10 in a similar fashion.

The social network channel 22 is in data communication with the TOS 12 or other data management server. Specifically, the TOS 12 or applicable software includes a username and a password field associated with a social network such as the Twitter® social media network. As a non-limiting example, the user name and password fields can be accommodated in a user profile saved in a database (not shown). As a further non-limiting example, the user name and password fields can be included as required fields of a pre-defined data template used in developing the associated marketing campaign. Additionally, the TOS 12 includes a campaign business logic to accommodate a workflow, as shown and described in detail below.

As a non-limiting example, the data communication between the TOS 12 and the social network channel 22 includes a plurality of Application Programming Interface (API) features 25 (e.g. commands, queries, and the like) for the associated social network (e.g. the Twitter® social media network). As a non-limiting example, the API features 25 include the following:
1) statuses/followers: returns a list of followers associated with an authenticating user, wherein the list includes a current status information associated with each of the followers;
2) users/show: returns an extended information of a given user (e.g., username, firstname, lastname, location, or other identification parameters), specified by an identification field or screen name as per the required identification parameter; and
3) direct_messages/new: sends a new direct message to a specified user from the authenticating user.

However, equivalent features for interaction with other social networks and subsequent versions of a Twitter API can be used, as appreciated by one skilled in the art.

The sitelet channel 24 includes a plurality of dynamic websites 26 (referred to as sitelets). The dynamic websites 26 (i.e. sitelets) are customized and personalized dynamically based upon information relating to an intended viewer. Each of the dynamic websites 26 can be accessed by following a personalized uniform resource locator 28 (i.e. PURL or TwURL), wherein the personalized uniform resource locator 28 is generated based upon information relating to the intended viewer. As a non-limiting example, where John Doe is the intended viewer of the dynamic websites 26, information relating to John Doe that is extracted by the TOS 12 (or stored on the associated database) is used to dynamically create a personalized website (i.e. the dynamic websites 26 or sitelet) having a uniform resource locator personalized to John Doe (e.g. http://www.marketingcampaign.com/John-Doe). As a further non-limiting example, the dynamic website 26 can be personalized using any information relating to the intended viewer including preferences, global position, background information, demographics, and the like. However, it is understood that any information can be used to personalize the dynamic website 26.

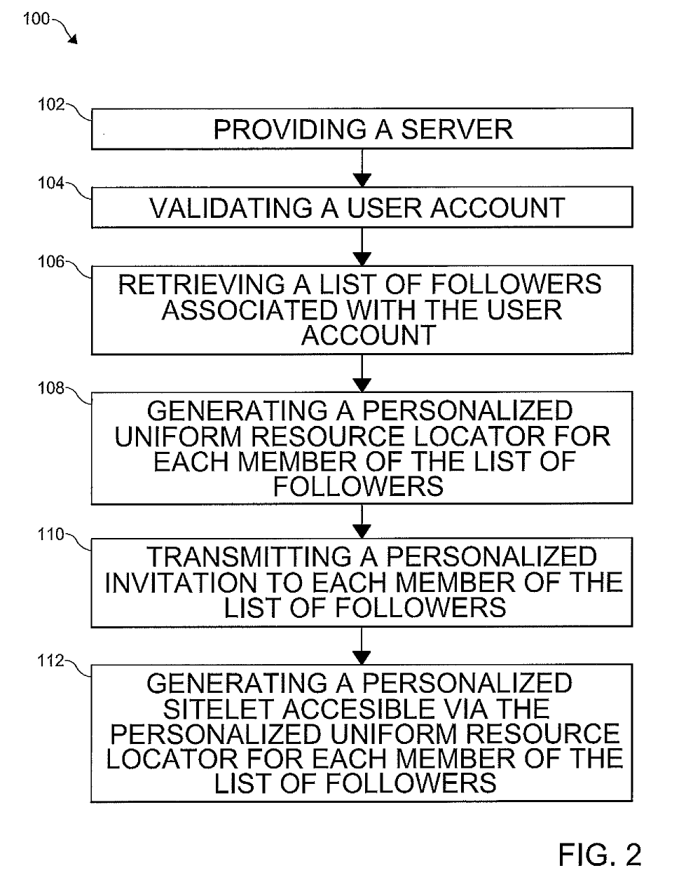

FIG. 2 illustrates a method 100 for directing a follower of a social network to a marketing site (i.e. workflow). It is understood that the method can be applied to any social network such as Twitter® social network, for example.

In step 102, a user selects, customizes, and orders a “social network campaign” (e.g. Twitter® social network campaign) using a pre-existing “campaign template” or “network template”, wherein the template has a plurality of pre-defined fields for customization, localization and personalization of a campaign messaging. It is understood that any template having any fields can be used to define any information relating to the marketing campaign, the user, and a follower of a user. It is further understood that other means of collecting and distributing information relating to the marketing campaign, the user, and a follower of the user, can be used.

In step 104, the TOS 12 validates a user account associated with a social network (e.g. the Twitter® social media network). As a non-limiting example, a simple API query (e.g. the users/show query) can be used to validate the user account.

In step 106, the TOS 12 retrieves a list of followers associated with the user account. As a non-limiting example, an API query (e.g. the statuses/followers query) can be used to retrieve the list of followers. As a further non-limiting example, the TOS 12 retrieves the list of followers only after a username and password associated with the user account of the social network are validated.

In step 108, the TOS 12 utilizes the returned list or array of followers as a “target list” for the social network campaign. As a non-limiting example, the TOS 12 executes a users/show API query to retrieve extended user information (e.g., first name, last name) relating to each of the members of the list of followers. As a further non-limiting example, the TOS 12 can use the extended information relating to each of the members of the list of followers to generate the personalized URL (i.e. PURL or TwURL) for each member of the list of followers.

In step 110, the TOS 12 launches the social network campaign by sending an individual personalized invitation to each of the members of the list of followers (i.e. target list), wherein each of the invitations is embedded with the personalized uniform resource locator 28 personalized for each of the intended recipient (i.e. members of the list of followers) of the invitation. As a non-limiting example, the invitations can be distributed using the direct_messages/new API command. As a further non-limiting example, the personalized uniform resource locator 28 is embedded in each of the invitations as a user-engageable hyperlink. It is understood that other means of distributing the invitations can be used. It is further understood that other means of following any one of the personalized uniform resource locators 28 can be used.

In step 112, the TOS 12 creates a personalized dynamic websites 26 (i.e. sitelet). As a non-limiting example, each of the personalized dynamic websites 26 is accessible via an associated one of the personalized uniform resource locators 28. As a further non-limiting example, each of the personalized dynamic websites 26 is customized, localized, and personalized for each member of the list of followers. In certain embodiments, each of the personalized dynamic websites 26 created by the TOS 12 includes customized information based upon the campaign template. In certain embodiments, each of the dynamic websites 26 is automatically generated in response to following one of the personalized uniform resource locators 28. For example, when “http://www.marketingcampaign.com/John-Doe” is followed, one of the dynamic websites 26 is generated and customized with information relating to John Doe. However, it is understood that any of the personalized uniform resource locators 28 can be linked to any one of the dynamic websites 26. It is further understood that the dynamic websites 26 can include any information (customized or standard).

In use, the social network components (e.g. Twitter® system and Twitter® client) continue to perform their respective functions of distributing and displaying Tweets® in a normal fashion, for example. The followers of the user (i.e. user account) originating the social network campaign receive a normal direct (personal) message (i.e. invitations) containing a web hyperlink (e.g. the personalized uniform resource locator 28) from the user originating the social network campaign, as described above. The followers who choose to respond by following the personalized uniform resource locator 28 are routed to the dynamic website 26 (i.e. sitelet).

The marketing system 10 and the method 100 for directing a follower of a social network to a marketing sitelet provide a means for advertisers to engage the social network users and followers in a personalized environment. The user of the marketing system 10 is able to create a single invitation which is personalized by the TOS 12 before being transmitted to the intended recipients (followers) in the social network of the user (i.e. a one-to-many distribution). Once one of the followers responds to the invitation, a personalized marketing sitelet is dynamically created to immerse the follower in a unique, personalized marketing environment.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A marketing system comprising:
a server for hosting a marking campaign, the server being in data communication with a social network channel, wherein the server distributes an invitation through the social network channel to a follower of a user of a social network associated with the social network channel; and
a sitelet channel in data communication with the server, wherein the sitelet channel includes a dynamic website, and wherein the invitation directs the follower of the user of the associated social network to the dynamic website.

2. The marketing system according to claim 1, wherein the server is a transaction operation server.

3. The marketing system according to claim 1, further comprising a user interface in data communication with the server to configure the marketing campaign.

4. The marketing system according to claim 1, further comprising an application programming interface to facilitate the data communication between the server and the social network channel.

5. The marketing system according to claim 4, wherein the application programming interface includes at least one of a statuses/followers feature, a user/show feature, and a direct_messages/new feature.

6. The marketing system according to claim 1, wherein the invitation includes a personalized uniform resource locator.

7. The marketing system according to claim 6, wherein personalized uniform resource locator identifies the dynamic website of the sitelet channel.

8. The marketing system according to claim 1, wherein the dynamic website includes customized information relating to the follower of the associated social network.

9. A method for directing a follower of a social network to a personalized marketing site, the method comprising the steps of:
retrieving a list of followers associated with a user account of the social network, the list of followers including personal information relating to each member of the list of followers;
generating a personalized uniform resource locator for at least one member of the list of followers based upon the personal information relating to the at least one member of the list of followers;
generating a dynamic website accessible via the personalized uniform resource locator; and
transmitting an invitation to the at least one member of the list of followers, the invitation embedded with the personalized uniform resource locator to direct the at least one member of the list of followers to the dynamic website.

10. The method according to claim 9, wherein the dynamic website includes customized information relating to the at least one member of the list of followers.

11. The method according to claim 9, including embedding the personalized uniform resource locator in the invitation as a user-engageable hyperlink.

12. The method according to claim 9, wherein the dynamic website is automatically generated in response to following the personalized uniform resource locator.

13. The method according to claim 12, further including in the dynamic website customized information relating to the at least one member of the list of followers associated with the personalized uniform resource locator that is followed.

14. The method according to claim 9, further comprising the step of validating a user account of the social network prior to the step of retrieving a list of followers associated with the user account of the social network.

15. A method for directing a follower of a social network to a personalized marketing site, the method comprising the steps of:
a. providing a server to host a marketing campaign including a campaign template having a plurality of pre-defined fields for customization, localization and personalization of campaign messaging;
b. wherein the server retrieves a list of followers associated with a social network user account, the list of followers including personal information associated with each of the followers;
c. wherein the server generates a personalized uniform resource locator for a follower from the list of followers based upon the personal information associated with the follower;
d. wherein the server transmits a personalized invitation to the follower, the invitation being embedded with the personalized uniform resource locator for the follower; and
e. wherein the server generates a dynamic website accessible via the personalized uniform resource locator.

16. The method according to claim 15, wherein the dynamic website includes customized information relating to the follower.

17. The method according to claim 15, wherein the personalized uniform resource locator is embedded in the invitation as a user-engageable hyperlink.

18. The method according to claim 15, wherein the dynamic website is automatically generated in response to following the personalized uniform resource locator.

19. The method according to claim 18, wherein the dynamic website includes customized information relating to the follower associated with the personalized uniform resource locator that is followed.

20. The method according to claim 15, further comprising the step of validating the user account of the social network prior to the step of retrieving a list of followers associated with the user account of the social network.
